(19) United States
(12) Patent Application Publication
(10) Pub. No.: US 2009/0197023 A1
(43) Pub. Date: Aug. 6, 2009

(54) PSEUDO MOONROOF FOR AUTOMOBILE

(76) Inventor: Su Hyun Lim, Los Angeles, CA (US)

Correspondence Address: IPLA P.A., 3580 WILSHIRE BLVD., 17TH FLOOR, LOS ANGELES, CA, 90010, US

(21) Appl. No.: 12/026,518

(22) Filed: Feb. 5, 2008

(51) Int. Cl. B60R 13/00; B44F 1/00

(52) U.S. Cl. 428/29; 428/31

(57) ABSTRACT

A pseudo moonroof for an automobile comprising a first sheet is provided. The first sheet comprises a top surface, a bottom surface configured to conform the roof of an automobile, and edges. The first sheet generates an optical illusion of a moonroof when viewed from outside. The first sheet may comprise one selected from a plastic film like a sun shade film, and a glass material. The sunshade film may comprise a partially reflective film configured to reflect at least part of incident light. The visual pattern may be generated by a magic board or a liquid crystal display. The pseudo moonroof may further include a second sheet, for example a fastening plate. The fastening plate attaches the pseudo moonroof detachably or permanently to the roof surface of the automobile.

### BACKGROUND OF THE INVENTION

The present invention relates to a pseudo moonroof for an automobile. More specifically, the invention relates to a pseudo moonroof looking real when viewed from an exterior of the automobile, where the pseudo moonroof can be attached or detached with ease to or from the automobile.

Moonroof or sunroof is an opening on the roof of an automobile. An automobile moonroof operates with a sliding door that opens and closes under a control mechanism. The moonroof allows air to flow in or out of the automobile. On the other hand, the moonroof may work as a decoration to improve the outlook of the automobile. Sometimes, a moonroof makes the automobile look more luxurious or cool.

Since a moonroof comes usually installed by manufacturers, an owner of the automobile has little control of the situation in which he/she wants a moonroof for some improvement of the appearance of the car without one. A market demand is a moonroof-mode fashion covering attachable on top of a moonroof free roof of an automobile.

### SUMMARY OF THE INVENTION

The present invention is contrived to solve the needs and problems in prior arts. An objective of the invention is to provide a pseudo moonroof.

Another objective of the invention is to provide a pseudo moonroof, which makes an automobile look better.

A further objective of the invention is to provide a pseudo moonroof, which is installed with ease.

A still further objective is to provide a pseudo moonroof adding fashion to an automobile.

In order to achieve these and other objectives, the invention provides a pseudo moonroof for an automobile. The pseudo moonroof for an automobile comprises a first sheet. The first sheet comprises a top surface, a bottom surface configured to conform a roof surface of the automobile, and a plurality of edges.

The first sheet is configured to generate an optical illusion of a moonroof when viewed from an exterior of the automobile. The first sheet may comprise one selected from a plastic film and a glass material. The plastic film may comprise a sun shade film. The sunshade film may comprise a partially reflective film configured to reflect at least part of incident light.

The first sheet may be translucent, and the top surface of the first sheet may be glossy. The first sheet may comprise a top layer and a bottom layer. The top layer may be translucent, and the bottom layer may comprise a visual pattern. The visual pattern may be seen through the top layer from the exterior. The visual pattern may be generated by a magic board which produces different optical images for different viewing angles.

Alternatively, the visual pattern may be generated by a liquid crystal display, and the liquid crystal display may be provided in the bottom layer of the first sheet. The pseudo moonroof may further comprise a second sheet provided on the bottom surface of the first sheet. The second sheet may comprise a fastening plate, and the fastening plate may be configured to attach the pseudo moonroof to the roof surface of the automobile.

The fastening plate may be configured to attach the pseudo moonroof detachably to the roof surface of the automobile. Alternatively, the fastening plate may be configured to attach the pseudo moonroof permanently to the roof surface of the automobile. The pseudo moonroof may be disposable. The fastening plate may comprise glue. The fastening plate may comprise a plurality of magnets.

The pseudo moonroof may further comprise one or more streamlined perimeter portions provided along at least one of the plurality of edges of the first sheet. Each of the one or more streamlined perimeter portions may be configured to form a streamlined surface with the roof surface of the automobile, such that friction against a flow of air over the streamlined surface is minimized and a downward force toward the roof surface is obtained. Each of the streamlined perimeter portions may comprise a thin membrane part. The thin membrane part may be adapted to stick to the roof surface airtight.

The each of the streamlined perimeter portions is integrated with the first sheet. The pseudo moonroof has numerous advantages in that: (1) the pseudo moonroof satisfies the fashion demand of a moonroof free automobile owner at a low cost; (2) the pseudo moonroof improves value of an automobile; and (3) the pseudo moonroof is detachably installed with ease.

Although the present invention is briefly summarized, the full understanding of the invention can be obtained by the following drawings, detailed description, and appended claims.

### BRIEF DESCRIPTION OF THE DRAWINGS

These and other features, aspects and advantages of the present invention will become better understood with reference to the accompanying drawings, wherein:

FIG. 1 is a schematic view of a pseudo moonroof installed on a rooftop of an automobile according to an embodiment of the invention;

FIG. 2 is a top plan view of a pseudo moonroof according to an embodiment of the invention;

FIG. 3 is a rear plan view of FIG. 2;

FIG. 4 is a cross-section view showing a pseudo moonroof along a horizontal line on FIG. 2 according to an embodiment of the invention; and

FIG. 5 is a cross-section view showing a pseudo moonroof according to another embodiment of the invention.

### DETAILED DESCRIPTION OF THE INVENTION

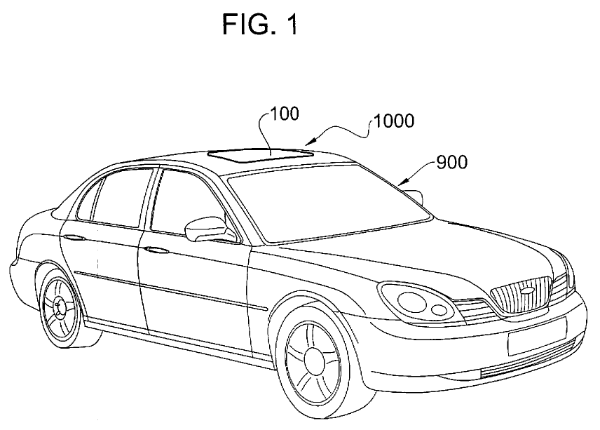

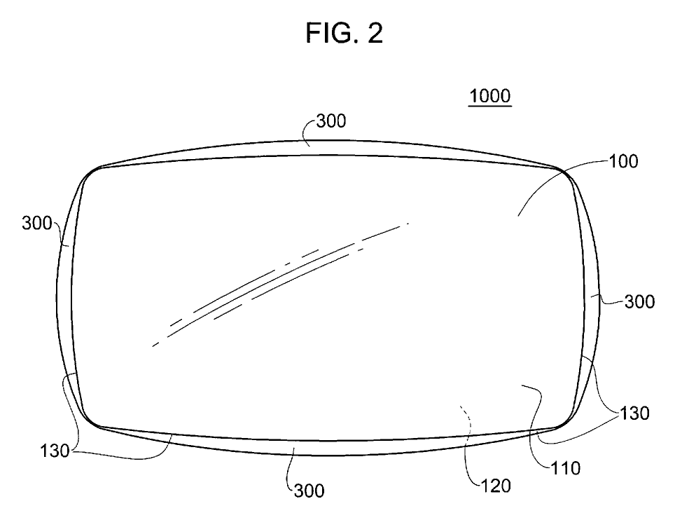

FIG. 1 shows a pseudo moonroof 1000 installed on a rooftop 900, or roof surface of an automobile. FIGS. 2-5 show pseudo moonroof 1000 according to embodiments of the invention.

An aspect of the invention provides a pseudo moonroof 1000 for an automobile. In an embodiment of the invention, the pseudo moonroof 1000 for an automobile comprises a first sheet 100. As shown in FIG. 1, the first sheet is attached on a part of the rooftop 900 of the automobile. The dimension of the first sheet 100, including width, length, thickness, and curvature is configured to look like a moonroof. The position of the pseudo moonroof 1000 is also determined to look like a moonroof. The position can be right above a driver's head or neighboring places.

The first sheet 100 comprises a top surface 110, a bottom surface 120 configured to conform the roof surface 900 of the automobile, and a plurality of edges 130. The edges 130 may be connected to both of the top surface 110 or the bottom surface 120. Alternatively, the edges 130 may be connected only to the top surface 110, and may not be connected to the bottom surface 120 directly. In certain embodiment, the edges 130 may be provided to include a single facing side. Further, the edges 130 may be formed in two facing sides to include front and rear sides of the automobile. Since the pseudo moonroof 1000 would not be subjected to wind blowing from side to side.

The first sheet 100 is configured to generate an optical illusion of a moonroof 1000 when viewed from an exterior of the automobile. The first sheet 100 may comprise a plastic film. Alternately, the first sheet 100 may comprise one selected from a plastic film and a glass material. The plastic film may comprise a sun shade film. The sun shade film may be of a kind which is used for tinting a window sometimes.

The sunshade film may comprise a partially reflective and partially transmissive film configured to reflect at least part of incident light. The first sheet 100 may be translucent, and the top surface 110 of the first sheet 100 may be glossy. The glossy surface of the first sheet 100 can give optical illusion to the first sheet 100.

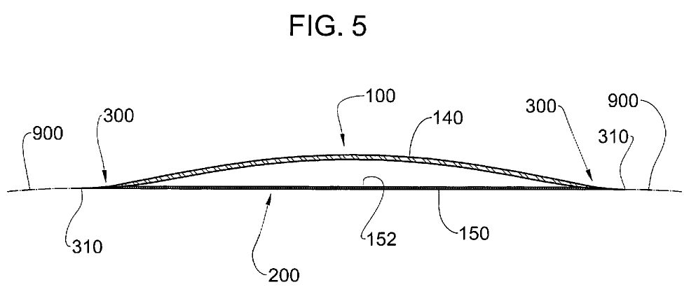

According to another embodiment of the invention as shown in FIG. 5, the first sheet 100 may comprise a top layer 140 and a bottom layer 150. The top layer 140 may be translucent, and the bottom layer 150 may comprise a visual pattern or visual pattern generator. The visual pattern may be seen through the top layer 140 from the exterior.

The visual pattern may be generated by a magic board producing different optical images for different viewing angles. Alternatively, the visual pattern may be generated by a liquid crystal display 152, and the liquid crystal display 152 may be provided in the bottom layer 150 of the first sheet 110. The liquid crystal display 152 can be driven by a video source including a computer, a video player, or even a video camera operating in real-time.

According to still another embodiment, the pseudo moonroof 1000 may further comprise a second sheet 200 provided on the bottom surface 120 of the first sheet 100. The second sheet 200 may comprise a fastening plate, and the fastening plate may be configured to attach the pseudo moonroof 1000 to the roof surface 900 of the automobile.

The fastening plate may be configured to attach the pseudo moonroof 1000 detachably to the roof surface 900 of the automobile. Alternatively, the fastening plate may be configured to attach the pseudo moonroof 1000 permanently to the roof surface 900 of the automobile. In certain embodiments, the pseudo moonroof 1000 may be disposable. The user may want to change the style or color of the pseudo moonroof 1000 now and then. The pseudo moonroof 1000 can be manufactured relatively cheaply. So, it is not going to be financially challenging to purchase two or more pseudo moonroofs 1000. The fastening plate may comprise glue.

In certain embodiments of the invention, the fastening plate may comprise a plurality of magnets 210, 220. The size or shape of the magnets 210, 220 may be changed according to the shape of the overall shape, size, weight of the pseudo moonroof 1000. The magnets 210, 220 may comprise metallic magnets and rubber magnets. Rubber magnets may form an air-tighter attachment.

According to another embodiment of the invention, the pseudo moonroof 1000 may further comprise one or more streamlined perimeter portions 300 provided along at least one of the plurality of edges 130 of the first sheet 100.

Each of the one or more streamlined perimeter portions 300 may be configured to form a streamlined surface with the roof surface 900 of the automobile, such that friction against a flow of air over the streamlined surface is minimized and a downward force toward the roof surface 900 is obtained. Each of the streamlined perimeter portions 300 may comprise a thin membrane part. The thin membrane part may be adapted to stick to the roof surface 900 airtight.

The each of the streamlined perimeter portions 300 may be integrated with the first sheet 100. As shown in the illustrated embodiment, the streamlined perimeter portions 300 gets thinner and thinner closer to edges so as to help the air-tight attachment of the pseudo moonroof 1000 to the rooftop 900 of the automobile.

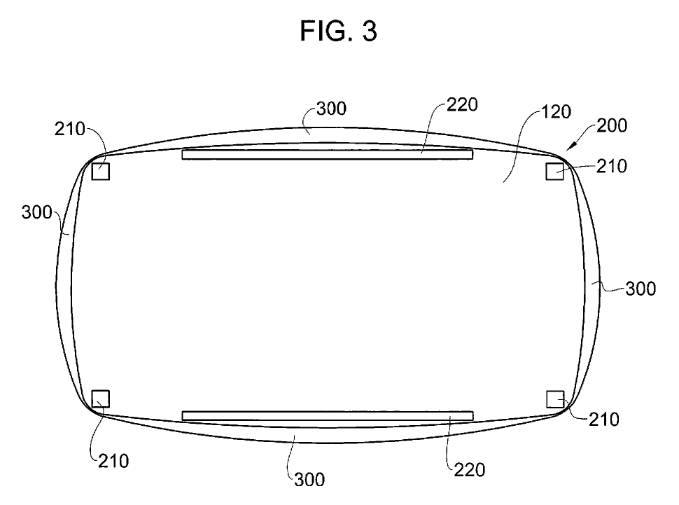

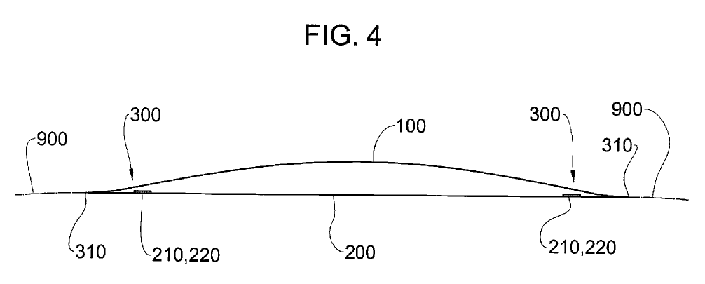

In certain embodiments as shown in FIGS. 3 and 4, the magnets 210, 220 can be disposed along, but not limited to, the edge of the second sheet 200 or fastening plate. The magnets 210, 220 can be disposed around central area of the second sheet 200. In still another embodiments, the second sheet 200 may be a sheet of rubber magnet itself.

In the illustrated embodiment, the magnets 210, 220 can be embedded in the second sheet 200 in order not to raise the second sheet 200 off the roof surface 900 of the automobile.

In certain embodiments of the invention, a pseudo moonroof can be made of a sun shade film with an elaborate shapes or variant thickness according to the portions, for example thin along the edge and thick in the central area.

While the invention has been shown and described with reference to different embodiments thereof, it will be appreciated by those skills in the art that variations in form, detail, compositions and operation may be made without departing from the spirit and scope of the invention as defined by the accompanying claims.

What is claimed is:

1. A pseudo moonroof for an automobile comprising:
a first sheet comprising a top surface, a bottom surface configured to conform with a roof surface of the automobile, and a plurality of edges,
wherein the first sheet is configured to generate an optical illusion of a moonroof when viewed from an exterior of the automobile.

2. The pseudo moonroof of claim 1, wherein the first sheet comprises one selected from a plastic film and a glass material.

3. The pseudo moonroof of claim 2, wherein the plastic film comprises a sun shade film.

4. The pseudo moonroof of claim 3, wherein the sunshade film comprises a partially reflective film configured to reflect at least part of incident light.

5. The pseudo moonroof of claim 1, wherein the first sheet is translucent, and wherein the top surface of the first sheet is glossy.

6. The pseudo moonroof of claim 1, wherein the first sheet comprises a top layer and a bottom layer, wherein the top layer is translucent, wherein the bottom layer comprises a visual pattern, and wherein the visual pattern is seen through the top layer from the exterior.

7. The pseudo moonroof of claim 6, wherein the visual pattern is generated by a magic board which produces different optical images for different viewing angles.

8. The pseudo moonroof of claim 6, wherein the visual pattern is generated by a liquid crystal display, and wherein the liquid crystal display is provided in the bottom layer of the first sheet.

9. The pseudo moonroof of claim 1, further comprising a second sheet provided on the bottom surface of the first sheet.

10. The pseudo moonroof of claim 9, wherein the second sheet comprises a fastening plate, and wherein the fastening plate is configured to attach the pseudo moonroof to the roof surface of the automobile.

11. The pseudo moonroof of claim 10, wherein the fastening plate is configured to attach the pseudo moonroof detachably to the roof surface of the automobile.

12. The pseudo moonroof of claim 10, wherein the fastening plate is configured to attach the pseudo moonroof permanently to the roof surface of the automobile.

13. The pseudo moonroof of claim 10, wherein the pseudo moonroof is disposable.

14. The pseudo moonroof of claim 10, wherein the fastening plate comprises glue.

15. The pseudo moonroof of claim 10, wherein the fastening plate comprises a plurality of magnets.

16. The pseudo moonroof of claim 1, further comprising one or more streamlined perimeter portions provided along at least one of the plurality of edges of the first sheet.

17. The pseudo moonroof of claim 16, wherein each of the one or more streamlined perimeter portions is configured to form a streamlined surface with the roof surface of the automobile, such that friction against a flow of air over the streamlined surface is minimized and a downward force toward the roof surface is obtained.

18. The pseudo moonroof of claim 1, wherein each of the streamlined perimeter portions comprises a thin membrane part.

19. The pseudo moonroof of claim 18, wherein the thin membrane part is adapted to stick to the roof surface airtight.

20. The pseudo moonroof of claim 1, wherein the each of the streamlined perimeter portions is integrated with the first sheet.
